(19) United States
(12) Patent Application Publication
(10) Pub. No.: US 2008/0247349 A1
(43) Pub. Date: Oct. 9, 2008

(54) METHOD, WIRELESS COMMUNICATION SYSTEM, TANGIBLE MACHINE-READABLE MEDIUM, AND COMMUNICATION APPARATUS FOR TRANSMITTING DOWNLINK HYBRID AUTOMATIC REPEAT REQUEST PACKETS BASED ON A MULTI-HOP RELAY STANDARD

(75) Inventors: Chih-Chiang HSIEH, Jen-Wu Township (TW); Shiann-Tsong SHEU, Taipei (TW); Hua-Chiang YIN, Guei-Shan Township (TW); Youn-Tai LEE, Yung-Ho City (TW); Kan-chei LOA, Taipei (TW); Yung-Ting LEE, Taipei (TW); Yi-Hsueh TSAI, Ban-Chiao (TW); Frank Chee-Da TSAI, Taipei (TW); Heng-Iang HSU, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/954,983

(22) Filed: Dec. 12, 2007

Related U.S. Application Data
(60) Provisional application No. 60/909,848, filed on Apr. 3, 2007.

(51) Int. Cl. H04B 7/14

(52) U.S. Cl. 370/315

(57) ABSTRACT

A method, a wireless communication system, a tangible machine-readable medium, and a communication apparatus for transmitting downlink hybrid automatic repeat request (HARQ) packets based on a multi-hop relay standard are provided. The wireless communication system comprises a BS, an SS, and a plurality of RSs. The BS transmits a plurality of first downlink HARQ packets to the RSs. After receiving one of the first downlink HARQ packets, at least one of the RSs replies a first ACK to the BS and retrieves a second downlink HARQ packet in the first downlink HARQ packet. Then, the at least one of the RSs transmits the second downlink HARQ packet to the SS. And the second downlink HARQ packet is the same as a part of one of the first downlink HARQ packets.

### CROSS-REFERENCES TO RELATED APPLICATIONS

This application claims the benefit of Provisional Application Ser. No. 60/909,848 filed on Apr. 3, 2007.

### BACKGROUND OF THE INVENTION

1. Field of the Invention

The present invention relates to a method, a wireless communication system, a tangible machine-readable medium, and a communication apparatus for transmitting downlink hybrid automatic repeat request (HARQ) packets based on a multi-hop relay standard.

2. Descriptions of the Related Art

Although the IEEE 802.16 standard already provides greater bandwidths, lower building cost, better service quality and expansibility, there still exist some defects of coverage and signal quality of the IEEE 802.16 standard. Therefore, the IEEE 802.16 Working Group established the Mobile Multihop Study Group in July, 2005 for building a multi-hop relay standard.

The HARQ packet, adopted in the IEEE 802.16j standard, is an advanced data retransmission strategy, which allows performing possible data retransmissions directly at the physical layer instead of the media access control (MAC) layer and/or higher layers. Since the HARQ packet is able to achieve data retransmission without involving mechanisms at the higher layers, the delay caused by data retransmission is significantly reduced. However, the HARQ packet still has some defects in a multi-hop relay system, which is going to be defined in the IEEE 802.16j standard.

When a subscriber station (SS), such as a mobile station (MS), or a base station (BS) transmits data, such as the HARQ packet, in a multi-hop relay stations (MRSs) network through relay stations (RSs) under IEEE 802.16j, an efficient solution is desired for fast exchanges of correct HARQ packets between end stations. With HARQ method, erroneously decoded HARQ packet is required to be retransmitted from the station to the subordinate one. If there are more than one station involved in reception of HARQ packet, any one of recipients, which have successfully received HARQ packet, is able to start forwarding data to the next hop. Therefore, BS could schedule multicast HARQ packets for multi-hop relay.

Accordingly, a solution to transmitting and relaying downlink HARQ packets based on a multi-hop relay standard, such as the IEEE 802.16j standard, is desired.

### SUMMARY OF THE INVENTION

One objective of this invention is to provide a method for transmitting downlink HARQ packets based on a multi-hop relay standard. The method comprises the following steps: transmitting a plurality of multicast downlink HARQ packets from a BS to a plurality of RSs; replying an acknowledgement character (ACK) from at least one of the RSs to the BS after the at least one of the RSs receives one of the multicast downlink HARQ packets; and transmitting a downlink HARQ packet from the at least one of the RSs to an SS. And the downlink HARQ packet is the same as a part of one of the multicast downlink HARQ packets.

Another objective of this invention is to provide a method for transmitting downlink HARQ packets based on a multi-hop relay standard. The method comprises the following steps: transmitting a plurality of multicast downlink HARQ packets from a BS to a plurality of RSs; replying ACKs from at least two of the RSs to the BS after the at least two of the RSs receive the multicast downlink HARQ packets respectively; and transmitting downlink HARQ packets from the at least two of the RSs to an SS. The downlink HARQ packets are the same as a part of one of the multicast downlink HARQ packets respectively, and are transmitted to the SS simultaneously.

Another objective of this invention is to provide a wireless communication system for transmitting a plurality of multicast downlink HARQ packets based on a multi-hop relay standard. The wireless communication system comprises a BS, an SS, and a plurality of RSs. The BS transmits a plurality of multicast downlink HARQ packets to the RSs. At least one of the RSs replies an ACK to the BS and transmits a downlink HARQ packet to the SS after receiving one of the multicast downlink HARQ packets. And the downlink HARQ packet is the same as a part of one of the multicast downlink HARQ packets.

Another objective of this invention is to provide a wireless communication system for transmitting a plurality of multicast downlink HARQ packets based on a multi-hop relay standard. The wireless communication system comprises a BS, an SS, and a plurality of RSs. The BS transmits a plurality of multicast downlink HARQ packets to the RSs. At least two of the RSs reply ACKs to the BS and transmit downlink HARQ packets to the SS after receiving two of the multicast downlink HARQ packets respectively. The downlink HARQ packets are the same as a part of one of the multicast downlink HARQ packets respectively, and are transmitted to the SS simultaneously.

Another objective of this invention is to provide a tangible machine-readable medium having executable code to cause a machine to perform a method for transmitting downlink HARQ packets based on a multi-hop relay standard. The method comprises the following steps: transmitting a plurality of multicast downlink HARQ packets from a BS to a plurality of RSs; replying an ACK from at least one of the RSs to the BS after the at least one of the RSs receives one of the multicast downlink HARQ packets; and transmitting a downlink HARQ packet from the at least one of the RSs to an SS. And the downlink HARQ packet is the same as a part of one of the multicast downlink HARQ packets.

Another objective of this invention is to provide a tangible machine-readable medium having executable code to cause a machine to perform a method for transmitting downlink HARQ packets based on a multi-hop relay standard. The method comprises the following steps: transmitting a plurality of multicast downlink HARQ packets from a BS to a plurality of RSs; replying ACKs from at least two of the RSs to the BS after the at least two of the RSs receive two of the multicast downlink HARQ packets respectively; and transmitting downlink HARQ packets from the at least two of the RSs to an SS. The downlink HARQ packets are the same as a part of one of the multicast downlink HARQ packets respectively, and are transmitted to the SS simultaneously.

Yet a further objective of this invention is to provide a communication apparatus for relaying a downlink HARQ packet based on a multi-hop relay standard. The communication apparatus comprises a receiving module, a processor, and a transmitting module. The receiving module receives a multicast downlink HARQ packet from a BS. The processor retrieves a downlink HARQ packet in the multicast downlink HARQ packet, wherein the downlink HARQ packet is the same as a part of the multicast downlink HARQ packet. The transmitting module transmits the downlink HARQ packet to an SS.

The aforesaid method can be executed by wireless communication apparatus, such as a BS or an RS in the wireless communication system. By transmitting a plurality of multicast downlink HARQ packets to a plurality of RSs, and transmitting at least one of downlink HARQ packets which is retrieved in one of the multicast downlink HARQ packets to an SS, such as an RS or an MS, this invention can transmit downlink HARQ packets to each SS of the wireless communication system based on a multi-hop relay standard.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a multi-hop relay wireless communication system of a first embodiment of the present invention;

FIG. 2 illustrates a block diagram of an RS of the first embodiment;

FIG. 3˜FIG. 7 illustrate diagrams of transmitting HARQ packets of the first embodiment;

FIG. 8 is a flow chart illustrating a second embodiment of the present invention; and

FIG. 9 is a flow chart illustrating a third embodiment of the present invention.

### DESCRIPTION OF THE PREFERRED EMBODIMENT

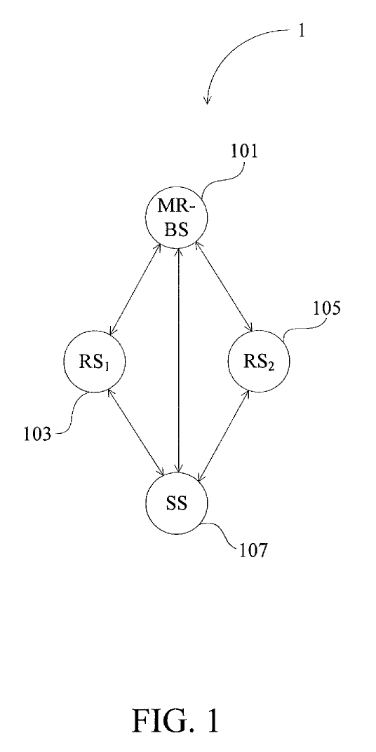

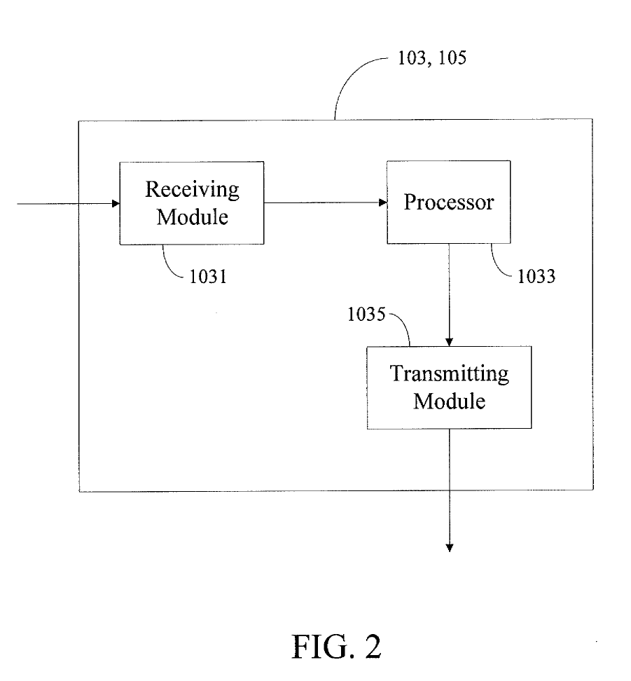

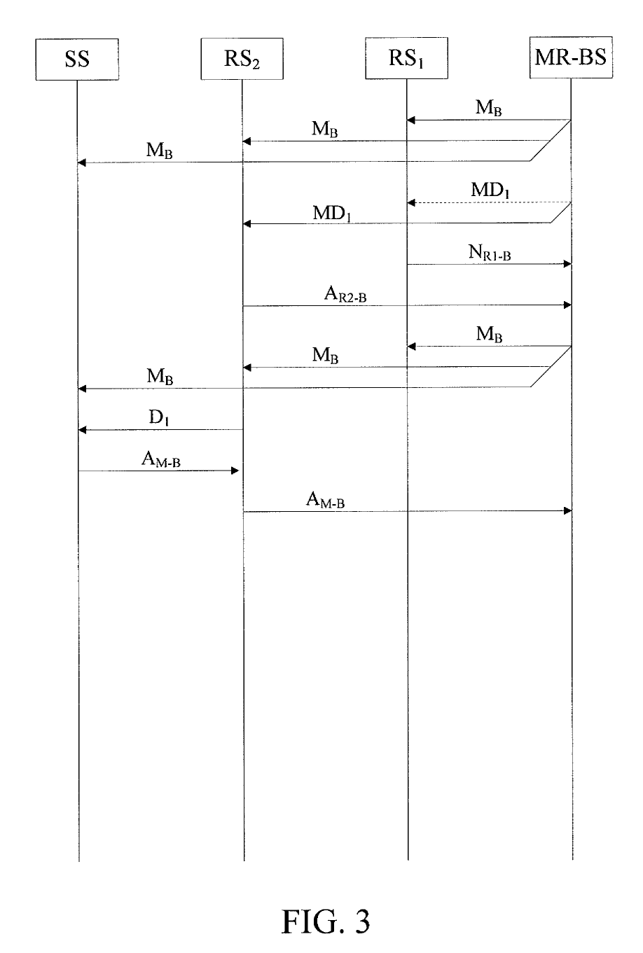

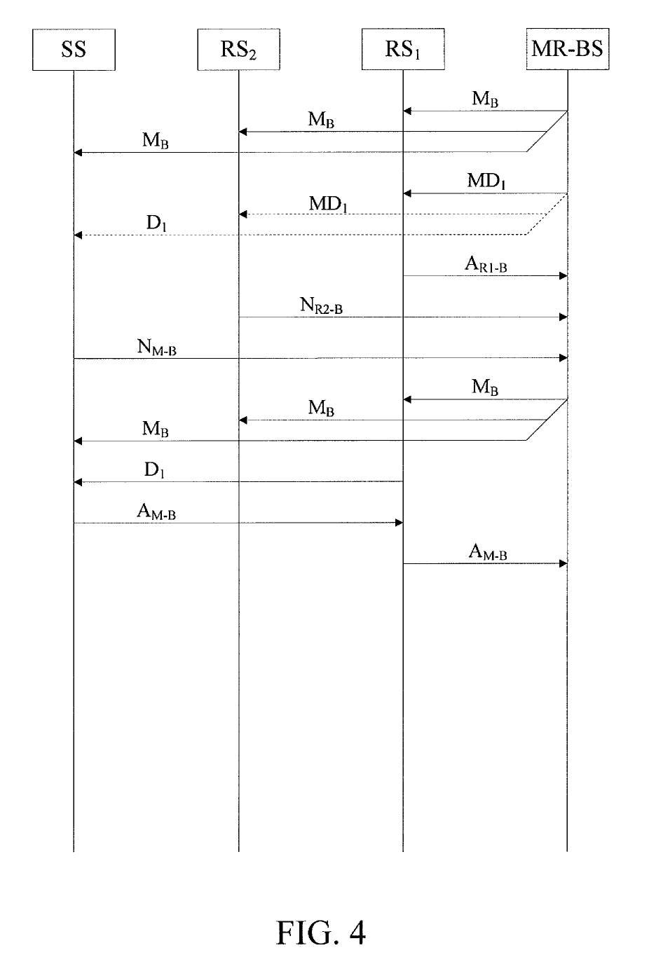

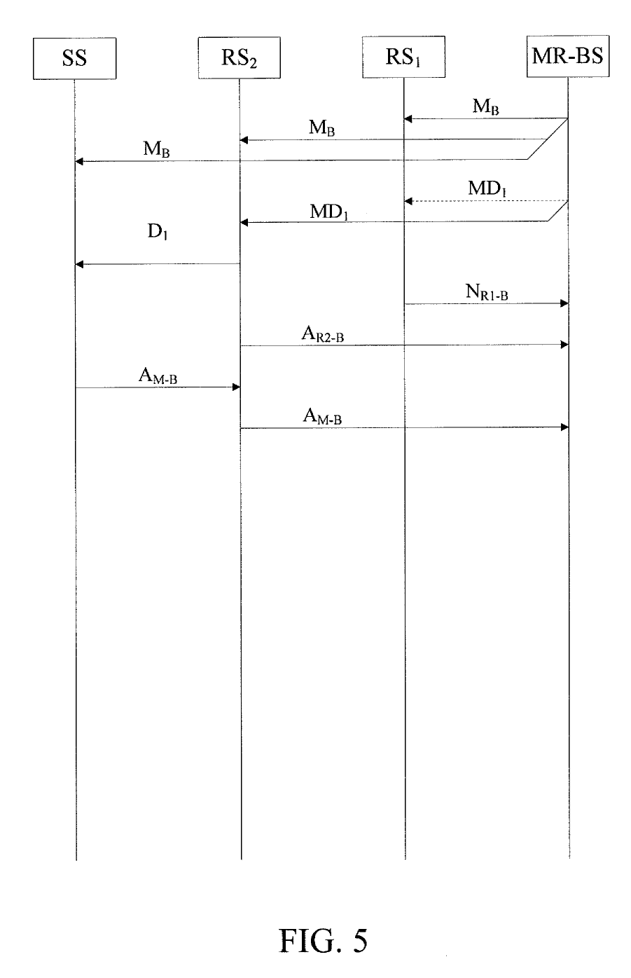

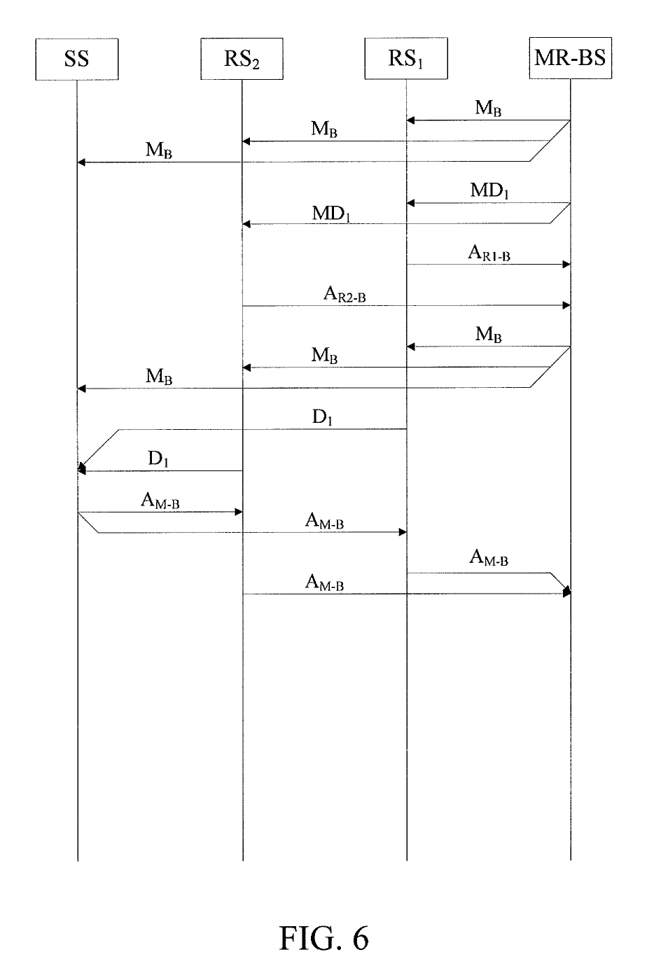

As illustrated in FIG. 1, a first embodiment of the present invention is a multi-hop relay wireless communication system 1 based on a multi-hop relay standard, such as the IEEE 802.16j standard. The multi-hop relay wireless communication system 1 comprises an MR-BS 101, a plurality of RSs 103, 105, and an SS 107. For the sake of simplification, two RSs (RS₁ 103, and RS₂ 105) are illustrated. The RSs 103, 105 of the multi-hop relay wireless communication system 1 is illustrated in FIG. 2, which comprises a receiving module 1031, a processor 1033, and a transmitting module 1035. The receiving module 1031 is adapted to receive multicast HARQ packets, such as a multicast downlink HARQ packet. The processor 1033 is adapted to retrieve a downlink HARQ packet in the multicast downlink HARQ packet. The transmitting module 1035 is adapted to transmit the retrieved downlink HARQ packet. The SS 107 can be another RS or an MS which can provide functions based on the multi-hop relay standard. The considered scenario is that RS₁ 103, RS₂ 105, and SS 107 can directly receive the information sent from the MR-BS 101. And some types of the transmitting of downlink HARQ packets of the multi-hop relay wireless communication system 1 are illustrated in FIG. 3 to FIG. 7.

FIG. 3 illustrates one type of hop-by-hop transmitting HARQ packets of the multi-hop relay wireless communication system 1 in a downlink case. In FIG. 3, the MR-BS 101 broadcasts MAPs M_{B} to the RS₁ 103, RS₂ 105, and SS 107 first. The MR-BS 101 assigns the RS₁ 103 and the RS₂ 105 to be in a multicast HARQ group. It means that the RS₁ 103 and the RS₂ 105 can receive each downlink HARQ packet and reply an ACK or a non-acknowledgement character (NACK) to the MR-BS 101. Then the MR-BS 101 transmits a plurality of multicast downlink HARQ packets MD₁ to the RS₁ 103 and the RS₂ 105. After the RS₁ 103 and the RS₂ 105 receive the multicast downlink HARQ packets MD₁, both the RS₁ 103 and the RS₂ 105 determine whether the received multicast downlink HARQ packet MD₁ is correct or not. It is assumed that the multicast downlink HARQ packet MD₁ received by the RS₁ 103 is not correct (shown by the dash line) and the multicast downlink HARQ packet MD₁ received by the RS₂ 105 is correct. Thus, the RS₁ 103 transmits an NACK N_{R1-B} to the MR-BS 101 and the RS₂ 105 transmits an ACK A_{R2-B} to the MR-BS 101. The MR-BS 101 is able to know the transmission statuses of the RS₁ 103 and the RS₂ 105 by the NACK N_{R1-B} and the ACK A_{R2-B}.

To be more specific, by receiving the NACK N_{R1-B} from the RS₁ 103 and receiving the ACK A_{R2-B} from the RS₂ 105, the MR-BS 101 knows that it can continue to transmit downlink HARQ packets to the SS 107 through the RS₂ 105 but not the RS₁ 103. After that, the MR-BS 101 broadcasts new MAPs M_{B} to the RS₁ 103, RS₂ 105, and SS 107. Then the RS₂ 105 retrieves a downlink HARQ packet D₁ in the multicast downlink HARQ packet MD₁ and transmits the downlink HARQ packet D₁ to the SS 107. Finally, the SS 107 determines whether the downlink HARQ packet D₁ is correct or not. If the downlink HARQ packet D₁ is correct, the SS 107 transmits an ACK A_{M-B} to the MR-BS 101 through the RS₂ 105. According to the receipt of the ACK and/or NACK, the MR-BS 101 can schedule the proper RS to forward downlink HARQ packets.

FIG. 4 illustrates another type of hop-by-hop transmitting HARQ packets of the multi-hop relay wireless communication system 1 in a downlink case. In FIG. 4, the MR-BS 101 broadcasts MAPs M_{B} to the RS₁ 103, RS₂ 105, and SS 107 first. The MR-BS 101 assigns the RS₁ 103 and the RS₂ 105 to be in a multicast HARQ group. It means that the RS₁ 103 and the RS₂ 105 can receive each downlink HARQ packet and reply an ACK or an NACK to the MR-BS 101. Then the MR-BS 101 intends to transmit a plurality of multicast downlink HARQ packets MD₁ to the RS₁ 103 and the RS₂ 105, and intends to transmit a downlink HARQ packet D₁ to the SS 107 directly. After the RS₁ 103 and the RS₂ 105 receive the downlink multicast downlink HARQ packets MD₁, each of the RS₁ 103 and the RS₂ 105 determine whether the received multicast downlink HARQ packet MD₁ is correct or not.

Similarly, the SS 107 determines whether the downlink HARQ packet D₁ is correct or not after the SS 107 receives the downlink HARQ packet D₁. It is assumed that the multicast downlink HARQ packet MD₁ received by the RS₁ 103 is correct, the multicast downlink HARQ packet MD₁ received by the RS₂ 105 is not correct (shown by the dash line), and the downlink HARQ packet D₁ received by the SS 107 is not correct (shown by the dash line). Thus, the RS₁ 103 transmits an ACK A_{R1-B} to the MR-BS 101, the RS₂ 105 transmits an NACK N_{R2-B} to the MR-BS 101, and the SS 107 transmits an NACK N_{M-B} to the MR-BS 101. The MR-BS 101 is able to know the transmission statuses of the RS₁ 103, the RS₂ 105, and the SS 107 according to the receipt of the ACK A_{R1-B}, the NACK N_{R2-B}, and the NACK N_{M-B}. That is, by receiving the ACK A_{R1-B}, the NACK N_{R2-B}, and the NACK N_{M-B}, the MR-BS 101 knows that it can continue to transmit data to the SS 107 through the RS₁ 103 but not RS₂ 105. After that, the MR-BS 101 transmits new MAPs M_{B} to the RS₁ 103, RS₂ 105, and SS 107. Then the RS₁ 103 retrieves the downlink HARQ packet D₁ in the multicast downlink HARQ packet MD₁ and transmits the downlink HARQ packet D₁ to the SS 107. Finally, the SS 107 determines whether the downlink HARQ packet D₁ is correct or not. If the downlink HARQ packet D₁ transmitted by the RS₁ 103 is correct, the SS 107 transmits an ACK A_{M-B} to the MR-BS 101 through RS₁ 103. According to the receipt of the ACK and/or NACK, the MR-BS 101 schedules the proper RS to forward data.

FIG. 5 illustrates one type of end-to-end transmitting HARQ packets of the multi-hop relay wireless communication system 1 in a downlink case. In FIG. 5, the MR-BS 101 broadcasts MAPs M_{B} to the RS₁ 103, RS₂ 105, and SS 107 first. The MR-BS 101 assigns the RS₁ 103 and the RS₂ 105 to be in a multicast HARQ group and the MR-BS 101 also allocates bandwidth for RS₂ 105 to forward HARQ packets to the SS 107. It means that the MR-BS 101 schedules RS₁ 103 and RS₂ 105 to receive multicast downlink HARQ packets and pre-schedules RS₂ 105 to forward downlink HARQ packets to the SS 107. Then the MR-BS 101 intends to transmit a plurality of multicast downlink HARQ packets MD₁ to the RS₁ 103 and the RS₂ 105. After the RS₁ 103 and the RS₂ 105 receive the multicast downlink HARQ packets MD₁, the RS₁ 103 determines whether the received multicast downlink HARQ packet MD₁ is correct or not, and the RS₂ 105 determines whether the received multicast downlink HARQ packet MD₁ is correct or not. It is assumed that the multicast downlink HARQ packet MD₁ received by the RS₁ 103 is not correct (shown by the dash line), the multicast downlink HARQ packet MD₁ received by the RS₂ 105 is correct, so the RS₁ 103 transmits an NACK N_{R1-B} to the MR-BS 101 and the RS₂ 105 transmits an ACK A_{R2-B} to the MR-BS 101.

Although the RS₁ 103 fails to receive the multicast downlink HARQ packet MD₁, the RS₂ 105 correctly receives the multicast downlink HARQ packet MD₁. Consequently, the RS₂ 105 can continue to transmit downlink HARQ packets to the SS 107. After that, the RS₂ 105 retrieves the downlink HARQ packet D₁ in the multicast downlink HARQ packet MD₁ and transmits the downlink HARQ packet D₁ to the SS 107. Finally, the SS 107 determines whether the downlink HARQ packet D₁ is correct or not. If the downlink HARQ packet D₁ is correct, the SS 107 transmits an ACK A_{M-B} to the MR-BS 101 through the RS₂ 105.

FIG. 6 illustrates one type of enhanced hop-by-hop transmitting HARQ packets of the multi-hop relay wireless communication system 1 in a downlink case. In FIG. 6, the MR-BS 101 broadcasts MAPs M_{B} to the RS₁ 103, RS₂ 105, and SS 107 first. The MR-BS 101 assigns the RS₁ 103 and the RS₂ 105 to be in a multicast HARQ group. It means that the RS₁ 103 and the RS₂ 105 can receive each downlink HARQ packet and reply an ACK or an NACK to the MR-BS 101. Then the MR-BS 101 transmits a plurality of multicast downlink HARQ packets MD₁ to the RS₁ 103 and the RS₂ 105. After the RS₁ 103 and the RS₂ 105 receive the multicast downlink HARQ packets MD₁, both the RS₁ 103 and the RS₂ 105 determine whether the received multicast downlink HARQ packet MD₁ is correct or not. It is assumed that the multicast downlink HARQ packet MD₁ received by the RS₁ 103 is correct and the multicast downlink HARQ packet MD₁ received by the RS₂ 105 is also correct. Thus, the RS₁ 103 transmits an ACK A_{R1-B} to the MR-BS 101 and the RS₂ 105 transmits an ACK A_{R2-B} to the MR-BS 101. The MR-BS 101 is able to know the transmission statuses of the RS₁ 103 and the RS₂ 105 by the ACK A_{R1-B} and the ACK A_{R2-B}.

To be more specific, by receiving the ACK A_{R1-B} from the RS₁ 103 and receiving the ACK A_{R2-B} from the RS₂ 105, the MR-BS 101 knows that it can continue to transmit downlink HARQ packets to the SS 107 through the RS₁ 103 and/or the RS₂ 105. After that, the MR-BS 101 broadcasts new MAPs M_{B} to the RS₁ 103, RS₂ 105, and SS 107. Then the RS₁ 103 retrieves a downlink HARQ packet D₁ in the multicast downlink HARQ packet MD₁ and transmits the downlink HARQ packet D₁ to the SS 107. Similarly, the RS₂ 105 retrieves another downlink HARQ packet D₁ in the multicast downlink HARQ packet MD₁ and transmits the downlink HARQ packet D₁ to the SS 107. By appropriate algorithm, the downlink HARQ packets D₁ transmitted by the RS₁ 103 and RS₂ 105 will arrive to the SS 107 simultaneously. Finally, the SS 107 determines whether the downlink HARQ packets D₁ are correct or not. If the downlink HARQ packets D₁ are correct, the SS 107 transmits ACKs A_{M-B} to the MR-BS 101 through the RS₁ 103 and RS₂ 105. According to the receipt of the ACK and/or NACK, the MR-BS 101 can schedule the proper RS to forward downlink HARQ packets.

FIG. 7 illustrates one type of enhanced end-by-end transmitting HARQ packets of the multi-hop relay wireless communication system 1 in a downlink case. In FIG. 7, the MR-BS 101 broadcasts MAPs M_{B} to the RS₁ 103, RS₂ 105, and SS 107 first. The MR-BS 101 assigns the RS₁ 103 and the RS₂ 105 to be in a multicast HARQ group. Then the MR-BS 101 transmits a plurality of downlink HARQ packets MD₁ to the RS₁ 103 and the RS₂ 105. After the RS₁ 103 and the RS₂ 105 receive the multicast downlink HARQ packets MD₁, both the RS₁ 103 and the RS₂ 105 determine whether the received multicast downlink HARQ packets MD₁ are correct or not. It is assumed that the multicast downlink HARQ packet MD₁ received by the RS₁ 103 is correct and the multicast downlink HARQ packet MD₁ received by the RS₂ 105 is also correct. After that, the MR-BS 101 broadcasts new MAPs M_{B} to the RS₁ 103, RS₂ 105, and SS 107. Then the RS₁ 103 retrieves a downlink HARQ packet D₁ in the multicast downlink HARQ packet MD₁ and transmits the downlink HARQ packet D₁ to the SS 107.

Similarly, the RS₂ 105 retrieves another downlink HARQ packet D₁ in the multicast downlink HARQ packet MD₁ and transmits the downlink HARQ packet D₁ to the SS 107. By appropriate algorithm, the downlink HARQ packets D₁ transmitted by the RS₁ 103 and RS₂ 105 will arrive to the SS 107 simultaneously. Finally, the SS 107 determines whether the downlink HARQ packets D₁ are correct or not. If the downlink HARQ packets D₁ are correct, the SS 107 transmits ACKs A_{M-B} to the MR-BS 101 through the RS₁ 103 and RS₂ 105.

The ACKs and NACKs which are illustrated in FIG. 3 to FIG. 7 are transmitted by one or more than one specific channels, in which those skilled in the art can understand the corresponding transmission of the ACKs and NACKs by the IEEE 802.16j standard, and thus detailed explanation is unnecessary.

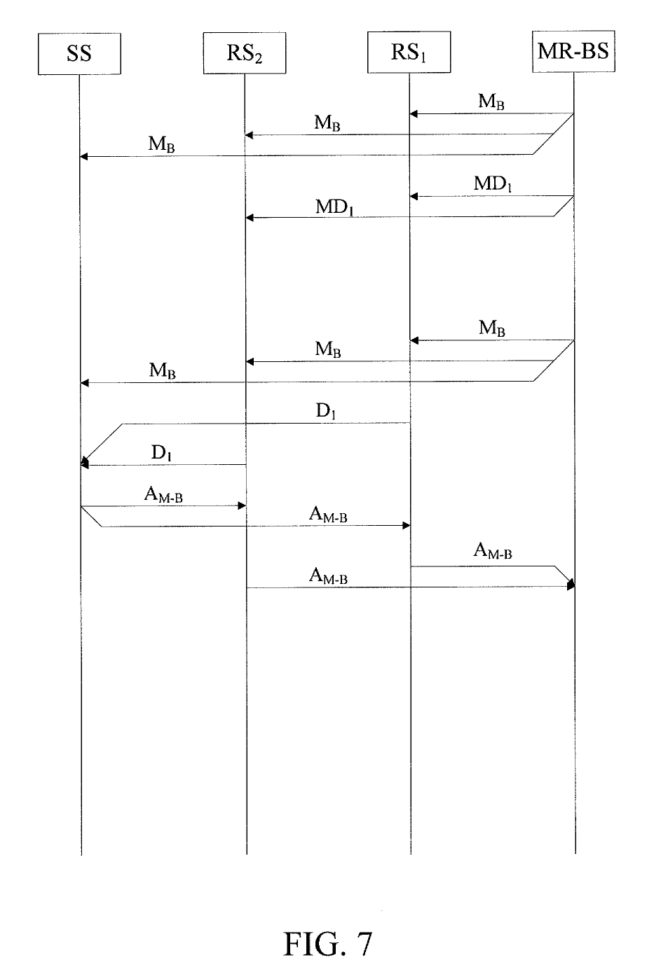

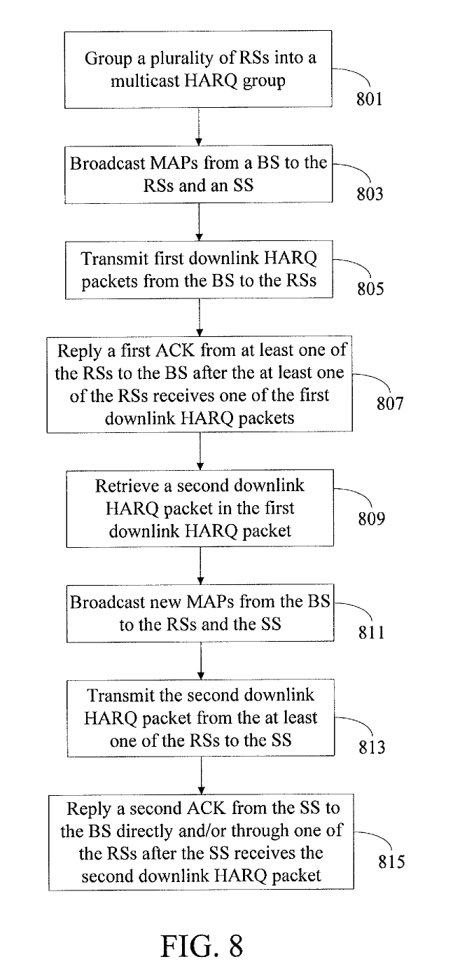

A second embodiment of this invention is a method for transmitting downlink HARQ packets based on a multi-hop relay standard, which is a method applied to the multi-hop relay wireless communication system 1 described in the first embodiment. More specifically, the HARQ packets transmission method of the second embodiment which is illustrated in FIG. 8 can be implemented by an application program controlling various modules of a wireless communication apparatus in the multi-hop relay wireless communication system 1. This application program may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The second embodiment of this invention illustrates hop-by-hop transmitting HARQ packets of the multi-hop relay wireless communication system 1 in a downlink case. In step 801, a plurality of RSs, such as the RS₁ 103 and RS₂ 105, are grouped into a multicast HARQ group. Next in step 803, MAPs are broadcasted from a BS, such as the MR-BS 101, to the RSs and an SS, such as the SS 107. In step 805, a plurality of first downlink HARQ packets are transmitted from the BS to the RSs. In step 807, a first ACK is replied from at least one of the RSs, such as one of the RS₁ 103 and RS₂ 105, to the BS after the at least one of the RSs receives one of the first downlink HARQ packets. In step 809, a second downlink HARQ packet is retrieved in the first downlink HARQ packet by the at least one of the RSs. In step 811, new MAPs are broadcasted from the BS to the RSs and the SS. In step 813, the second downlink HARQ packet is transmitted from the at least one of the RSs to the SS. Finally, in step 815, a second ACK is replied from the SS to the BS directly and/or through one of the RSs after the SS receives the second downlink HARQ packet.

In addition to the steps revealed in FIG. 8, the second embodiment can also execute all the operations of the first embodiment, in which those skilled in the art can understand the corresponding steps and operations of the second embodiment by the explanation of the first embodiment, and thus detailed description in this regard is not given.

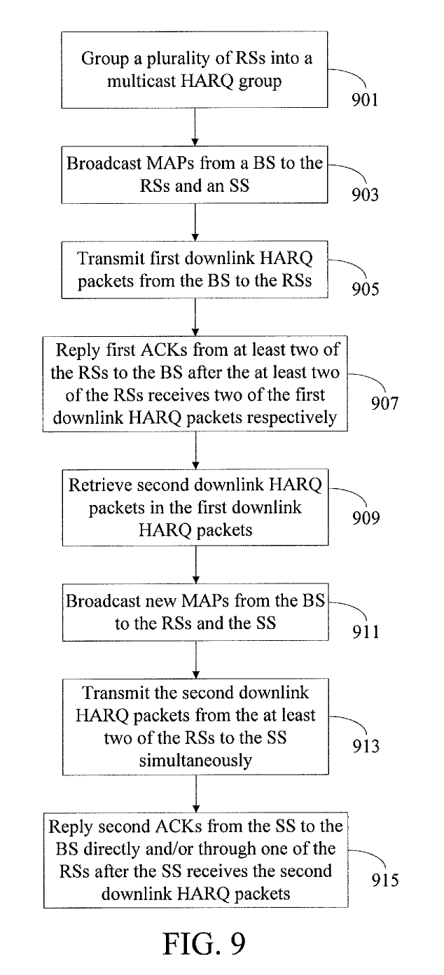

A third embodiment of this invention is a method for transmitting downlink HARQ packets based on a multi-hop relay standard, which is a method applied to the multi-hop relay wireless communication system 1 described in the first embodiment. More specifically, the HARQ packets transmission method of the third embodiment which is illustrated in FIG. 9 can be implemented by an application program controlling various modules of a wireless communication apparatus in the multi-hop relay wireless communication system 1. This application program may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The third embodiment of this invention illustrates enhanced hop-by-hop transmitting HARQ packets of the multi-hop relay wireless communication system 1 in a downlink case. In step 901, a plurality of RSs, such as the RS₁ 103 and RS₂ 105, are grouped into a multicast HARQ group. Next in step 903, MAPs are broadcasted from a BS, such as the MR-BS 101, to the RSs and an SS, such as the SS 107. In step 905, a plurality of first downlink HARQ packets are transmitted from the BS to the RSs. In step 907, first ACKs are replied from at least two of the RSs, such as the RS₁ 103 and RS₂ 105, to the BS after the at least two of the RSs receive two of the first downlink HARQ packets respectively. In step 909, second downlink HARQ packets are retrieved in the first downlink HARQ packets by the at least two of the RSs respectively. In step 911, new MAPs are broadcasted from the BS to the RSs and the SS. In step 913, the second downlink HARQ packets are simultaneously transmitted from the at least two of the RSs to the SS. Finally, in step 915, second ACKs are replied from the SS to the BS directly and/or through one of the RSs after the SS receives the second downlink HARQ packets.

In addition to the steps revealed in FIG. 9, the third embodiment can also execute all the operations of the first embodiment, in which those skilled in the art can understand the corresponding steps and operations of the third embodiment by the explanation of the first embodiment, and thus detailed description in this regard is not given.

Accordingly, by transmitting multicast downlink HARQ packets to a plurality of RSs, and transmitting at least one of downlink HARQ packets which is retrieved in one of the multicast downlink HARQ packets to an SS, such as an RS or an MS, this invention can transmit downlink HARQ packets to each SS of the wireless communication system based on a multi-hop relay standard.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for transmitting downlink hybrid automatic repeat request (HARQ) packets based on a multi-hop relay standard, comprising the steps of:
transmitting a plurality of first downlink HARQ packets from a base station (BS) to a plurality of first relay stations (RSs);
replying a first acknowledgement character (ACK) from at least one of the first RSs to the BS after the at least one of the first RSs receives one of the first downlink HARQ packets; and
transmitting a second downlink HARQ packet from the at least one of the first RSs to a subscriber station (SS);
wherein the second downlink HARQ packet is the same as a part of one of the first downlink HARQ packets.

2. The method as claimed in claim 1, further comprising a step of grouping the first RSs into a multicast HARQ group.

3. The method as claimed in claim 1, wherein the SS is one of a second RS and a mobile station (MS).

4. The method as claimed in claim 1, further comprising a step of replying a second ACK from the SS to the BS directly after receiving the second downlink HARQ packet.

5. The method as claimed in claim 1, further comprising a step of replying a second ACK from the SS to the BS through one of the first RSs after receiving the second downlink HARQ packet.

6. The method as claimed in claim 1, further comprising a step of broadcasting MAPs from the BS to the first RSs and the SS.

7. A method for transmitting downlink HARQ packets based on a multi-hop relay standard, comprising the steps of:
transmitting a plurality of first downlink HARQ packets from a BS to a plurality of first RSs;
replying first ACKs from at least two of the first RSs to the BS after the at least two of the first RSs receive two of the first downlink HARQ packets respectively; and
transmitting second downlink HARQ packets from the at least two of the first RSs to an SS;
wherein the second downlink HARQ packets are the same as a part of one of the first downlink HARQ packets respectively, and are transmitted to the SS simultaneously.

8. The method as claimed in claim 7, further comprising a step of grouping the first RSs into a multicast HARQ group.

9. The method as claimed in claim 7, wherein the SS is one of a second RS and an MS.

10. The method as claimed in claim 7, further comprising a step of replying a second ACK from the SS to the BS directly after receiving the second downlink HARQ packets.

11. The method as claimed in claim 7, further comprising a step of replying a second ACK from the SS to the BS through one of the first RSs after receiving the second downlink HARQ packets.

12. The method as claimed in claim 7, further comprising a step of broadcasting MAPs from the BS to the first RSs and the SS.

13. A wireless communication system for transmitting downlink HARQ packets based on a multi-hop relay standard, comprising:
a plurality of first RSs;
an SS; and
a BS for transmitting a plurality of first downlink HARQ packets to the first RSs;
wherein at least one of the first RSs replies a first ACK to the BS and transmits a second downlink HARQ packet to the SS after receiving one of the first downlink HARQ packets, the second downlink HARQ packet is the same as a part of one of the first downlink HARQ packets.

14. The wireless communication system as claimed in claim 13, wherein the BS groups the first RSs into a multicast HARQ group, the first downlink HARQ packet is transmitted in response to the multicast HARQ group.

15. The wireless communication system as claimed in claim 13, wherein the SS is one of a second RS and an MS.

16. The wireless communication system as claimed in claim 13, wherein the SS replies a second ACK to the BS directly after receiving the second downlink HARQ packet.

17. The wireless communication system as claimed in claim 13, wherein the SS replies a second ACK to the BS through one of the first RSs after receiving the second downlink HARQ packet.

18. The wireless communication system as claimed in claim 13, wherein the BS broadcasts MAPs to the first RSs and the SS.

19. A wireless communication system for transmitting downlink HARQ packets based on a multi-hop relay standard, comprising:
a plurality of first RSs;
an SS; and
a BS for transmitting a plurality of first downlink HARQ packets to the first RSs;
wherein at least two of the first RSs reply first ACKs to the BS and transmit second downlink HARQ packets to the SS after receiving two of the first downlink HARQ packets respectively, the second downlink HARQ packets are the same as a part of one of the first downlink HARQ packets respectively, and are transmitted to the SS simultaneously.

20. The wireless communication system as claimed in claim 19, wherein the BS groups the first RSs into a multicast HARQ group, the first downlink HARQ packets are transmitted in response to the multicast HARQ group.

21. The wireless communication system as claimed in claim 19, wherein the SS is one of a second RS and an MS.

22. The wireless communication system as claimed in claim 19, wherein the SS replies a second ACK to the BS directly after receiving the second downlink HARQ packets.

23. The wireless communication system as claimed in claim 19, wherein the SS replies a second ACK to the BS through one of the first RSs after receiving the second downlink HARQ packets.

24. The wireless communication system as claimed in claim 19, wherein the BS broadcasts MAPs to the first RSs and the SS.

25. A tangible machine-readable medium having executable code to cause a machine to perform a method for transmitting downlink HARQ packets based on a multi-hop relay standard, the method comprising steps of:
transmitting a plurality of first downlink HARQ packets from a BS to a plurality of first RSs;
replying a first ACK from at least one of the first RSs to the BS after the at least one of the first RSs receives one of the first downlink HARQ packets; and
transmitting a second downlink HARQ packet from the at least one of the first RSs to an SS;
wherein the second downlink HARQ packet is the same as a part of one of the first downlink HARQ packets.

26. The tangible machine-readable medium as claimed in claim 25, wherein the method further comprises a step of grouping the first RSs into a multicast HARQ group.

27. The tangible machine-readable medium as claimed in claim 25, wherein the SS is one of a second RS and an MS.

28. The tangible machine-readable medium as claimed in claim 25, wherein the method further comprises a step of replying a second ACK from the SS to the BS directly after receiving the second downlink HARQ packet.

29. The tangible machine-readable medium as claimed in claim 25, wherein the method further comprises a step of replying a second ACK from the SS to the BS through one of the first RSs after receiving the second downlink HARQ packet.

30. The tangible machine-readable medium as claimed in claim 25, wherein the method further comprises a step of broadcasting MAPs from the BS to the first RSs and the SS.

31. A tangible machine-readable medium having executable code to cause a machine to perform a method for transmitting downlink HARQ packets based on a multi-hop relay standard, the method comprising steps of:
transmitting a plurality of first downlink HARQ packets from a BS to a plurality of first RSs;
replying first ACKs from at least two of the first RSs to the BS after the at least two of the first RSs receive two of the first downlink HARQ packets respectively; and
transmitting second downlink HARQ packets from the at least two of the first RSs to an SS;
wherein the second downlink HARQ packets are the same as a part of one of the first downlink HARQ packets respectively, and are transmitted to the SS simultaneously.

32. The tangible machine-readable medium as claimed in claim 31, wherein the method further comprises a step of grouping the first RSs into a multicast HARQ group.

33. The tangible machine-readable medium as claimed in claim 31, wherein the SS is one of a second RS and an MS.

34. The tangible machine-readable medium as claimed in claim 31, wherein the method further comprises a step of replying a second ACK from the SS to the BS directly after receiving the second downlink HARQ packets.

35. The tangible machine-readable medium as claimed in claim 31, wherein the method further comprises a step of replying a second ACK from the SS to the BS through one of the first RSs after receiving the second downlink HARQ packets.

36. The tangible machine-readable medium as claimed in claim 31, wherein the method further comprises a step of broadcasting MAPs from the BS to the first RSs and the SS.

37. A communication apparatus for relaying a downlink HARQ packet based on a multi-hop relay standard, comprising:
a receiving module for receiving a first downlink HARQ packet from a BS;
a processor for retrieving a second downlink HARQ packet in the first downlink HARQ packet, wherein the second downlink HARQ packet is the same as a part of the first downlink HARQ packet; and
a transmitting module for transmitting the second downlink HARQ packet to one of an SS.

38. The communication apparatus as claimed in claim 37, wherein the SS is one of an RS and an MS.
